(19) United States
(12) Patent Application Publication
(10) Pub. No.: US 2025/0297993 A1
(43) Pub. Date: Sep. 25, 2025

(54) SOFT ROBOT FOR NON-DESTRUCTIVE TESTING

(71) Applicant: Government of the United States as represented by the Secretary of the Air Force, Wright-Patterson AFB, OH (US)

(72) Inventors: Abigail Juhl, Bellbrook, OH (US); Carson Willey, Beavercreek, OH (US); Vincent Chen, Dayton, OH (US); LoriAnne Groo, Dayton, OH (US)

(21) Appl. No.: 19/057,364

(22) Filed: Feb. 19, 2025

Related U.S. Application Data
(60) Provisional application No. 63/569,378, filed on Mar. 25, 2024.

(51) Int. Cl. G01N 29/22; B25J 18/06; G01N 29/04

(52) U.S. Cl. CPC G01N 29/223; B25J 18/06; G01N 29/04; G01N 2291/0289

(57) ABSTRACT

A non-destructive testing (NDT) system including: a flexible ultrasound array including an array surface; a controller for controlling the flexible ultrasound array; and an actuatable soft robot system comprising an actuator mechanism for actuating the flexible ultrasound array to modify a shape of the array surface of the flexible ultrasound array.

Pursuant to 37 C.F.R. § 1.78(a)(4), this application claims the benefit of and priority to prior filed co-pending Provisional Application Ser. No. 63/569,378, filed Mar. 25, 2024, which is expressly incorporated herein by reference in its entirety.

### RIGHTS OF THE GOVERNMENT

The disclosure described herein may be manufactured and used by or for the Government of the United States for all governmental purposes without the payment of any royalty.

### FIELD OF THE INVENTION

The present invention relates generally to robotics for inspection and, more particularly, to soft robotic systems with integrated ultrasound for non-destructive testing.

### BACKGROUND OF THE INVENTION

Current non-destructive testing (NDT) (also referred to as non-destructive evaluation (NDE)) equipment may be insufficient for accessing necessary portions of a tested article, object, or system. Hence, these inaccessible areas may be difficult or impossible to sufficiently test. Moreover, NDT is often implemented to evaluate systems of utmost criticality. For example, military aircraft, maritime, and other applications (e.g., oil and gas pipelines, nuclear components, medical inspection, integrated circuits, windmills, etc.) are often tested with NDT systems. Marine and aircraft applications, for example, can require NDT-tested systems to operate under extreme circumstances in austere environments. Because NDT testing of such systems is a critical capability, any aspects that are capable of increasing the flexibility and accessibility of NDT systems ought to be explored. Additionally, flexible and more useful systems may enable testing of systems in situ, which can reduce cost and time of testing. Making testing systems more flexible or adaptable to the systems that they will test may maximize the chances of identifying and correcting deviations and deformities in components and systems. Additionally, because of the high cost and difficulty of operation of current NDT systems, new robust but cost-effective systems may be required.

### SUMMARY OF THE INVENTION

The present invention overcomes the foregoing problems and other shortcomings, drawbacks, and challenges of NDT for critical systems. While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present disclosure, a non-destructive testing (NDT) system includes a flexible ultrasound array including an array surface; a controller for controlling the flexible ultrasound array; and an actuatable soft robot system comprising an actuator mechanism for actuating the flexible ultrasound array to modify a shape of the array surface of the flexible ultrasound array.

According to another embodiment of the present disclosure, a flexible ultrasound robot for non-destructive testing includes a head including: a coupler for coupling the flexible ultrasound robot to a controller; a fluid interface for coupling the flexible ultrasound robot with a fluid supply and fluid return for controlling a motion of the flexible ultrasound robot, a body comprising: a flexible ultrasound array including an array surface; and an actuatable soft robot system comprising an actuator mechanism for actuating the flexible ultrasound array to flex the array surface of the flexible ultrasound array.

Additional objects, advantages, and novel features of the disclosure will be set forth in part in the description which follows, and in part will become apparent to those skilled in the art upon examination of the following or may be learned by practice of the disclosure. The objects and advantages of the disclosure may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present disclosure and, together with a general description of the disclosure given above, and the detailed description of the embodiments given below, serve to explain the principles of the present disclosure.

FIG. 1 shows non-destructive testing (NDT) system including a flexible ultrasound array and an actuatable soft robot system, according to one or more embodiments shown and described herein.

FIG. 2 shows further details of the NDT system of FIG. 1.

FIG. 3 shows further details of the NDT system of FIG. 1.

FIG. 4 shows further details of the NDT system of FIG. 1 including a robot crawler for moving the NDT system along a test workpiece.

It should be understood that the appended drawings are not necessarily to scale, presenting a somewhat simplified representation of various features illustrative of the basic principles of the disclosure. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following examples illustrate particular properties and advantages of some of the embodiments of the present disclosure. Furthermore, these are examples of reduction to practice of the present disclosure and confirmation that the principles described in the present disclosure are therefore valid but should not be construed as in any way limiting the scope of the disclosure.

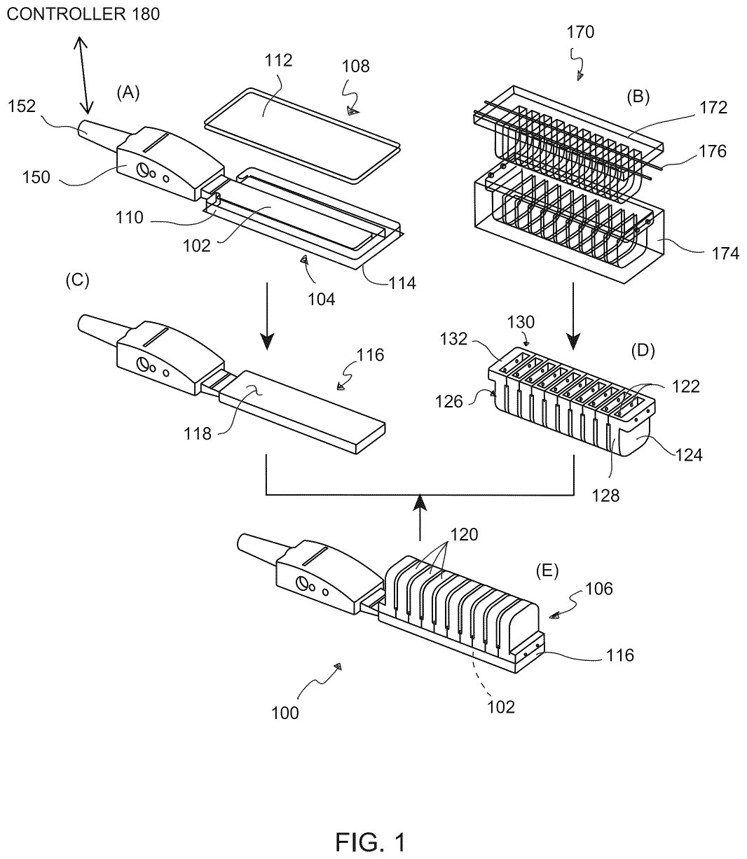

As briefly mentioned above, increasing the flexibility and mobility of NDT systems could enable NDT and allow it to proliferate. This could, in turn, maximize the chances of identifying and correcting deviations and deformities in components and systems. FIG. 1 shows a low cost and robust non-destructive testing (NDT) system for testing components and systems.

FIG. 1 shows an NDT system 100 being formed in various steps (Steps A, B, C, D, and E). The NDT system 100 includes a flexible ultrasound array 102 with an array surface 104. The flexible ultrasound array 102 may be coupled to a controller (not shown) via a coupler 150 and wire 152 for communicatively coupling the flexible ultrasound array 102 with the controller. The flexible ultrasound array 102 may be physically controlled by an actuatable soft robot system 106. As will be explained in greater detail herein, the actuatable soft robot system 106 may be actuated using a pneumatic actuator.

Referring to FIG. 1, Steps A and C, the flexible ultrasound array 102 may be positioned in a mold 108. The mold 108 may be filled with a resin (e.g., acrylic, epoxy, polyester, polyurethane, phenolic, alkyd, etc.) The resin may set to form a flexible housing 116. The mold 108 includes a sidewall 110, a top wall 112, and a bottom wall 114. Hence, one or more of the walls may be formed of acrylic (e.g., an acrylic mold). In some instances, one or more portions of the mold 108 may be laser cut to form a cavity in which the flexible ultrasound array 102 may be placed. In some instances, one or more portions of the housing 116 can be formed of one or more flexible materials (e.g., silicone elastomer, polytetrafluoroethylene (PTFE) tape) such that the flexible ultrasound array 102 can flex inside the housing 116 to wrap around a test subject (e.g., a pipe, a casing, etc.) In some embodiments, the housing 116 may include a top surface 118 that can serve as an interface between the flexible ultrasound array 102 and the actuatable soft robot system 106 such that the flow of air or other fluid can be controlled to the actuatable soft robot system 106 to control the movement of the actuatable soft robot system 106 and therethrough the movement of the flexible ultrasound array 102 as described in greater detail herein. In one or more embodiments, the housing 116, and/or one or more other components is bonded with the flexible ultrasound array 102, the actuatable soft robot system 106, and/or one or more other components of the NDT system 100 (e.g., using silicone or another flexible bonding substance).

Referring to FIG. 1, Steps C, D, and E, the NDT system 100 includes the flexible ultrasound array 102 (shown inside the flexible housing 116 in FIG. 1, Step C) and the actuatable soft robot system 106. The actuatable soft robot system 106 can include a series of retractable segments 120 including a chamber 130. In the embodiment shown, each of the chambers 130 is fluidly coupled to a subsequent and/or preceding chamber 130 via one or more fluid ports 122. However, it is contemplated that one or more of the chambers 130 can be fluidly isolatable from one or more of the others such that the chambers 130 can be individually or selectively inflated. This individual or selective inflation can result in a non-constant curvature of the flexible ultrasound array 102. The actuatable soft robot system 106 can have any number of retractable segments 120 and the retractable segments can each be of the same or varying sizes. The overall length of the actuatable robot system 106 can in part be determined by the number of retractable segments 120.

Each retractable segment 120 includes one or more expandable portions and one or more rigid portions. For example, the retractable segments 120 shown in FIG. 1 encase the chamber 130 with a front wall 124 and a rear wall 126 that are expandable and a side wall 128 that is rigid. As shown, the retractable segments 120 may comprise one or more thin, flat panels capable of expanding to contact and push another of the retractable segments and to retract so as to put less or no pressure on an adjacent segment. That is, certain walls of the retractable segments 120 can move in and out to cause movement of the actuatable soft robot system 106. The actuatable soft robot 106 can be fixed adjacent (e.g., on top of) the housing 116 of the flexible ultrasound array 102 such that the top surface 118 of the flexible ultrasound array 102 seals one or more (e.g., all) of the chambers 130. The chamber 130 can be filled with fluid such that the front wall 124 and/or the rear wall 126 of any given segment 120 can expand, pressing against a neighboring retractable segment 120 to actuate the actuatable soft robot system 106.

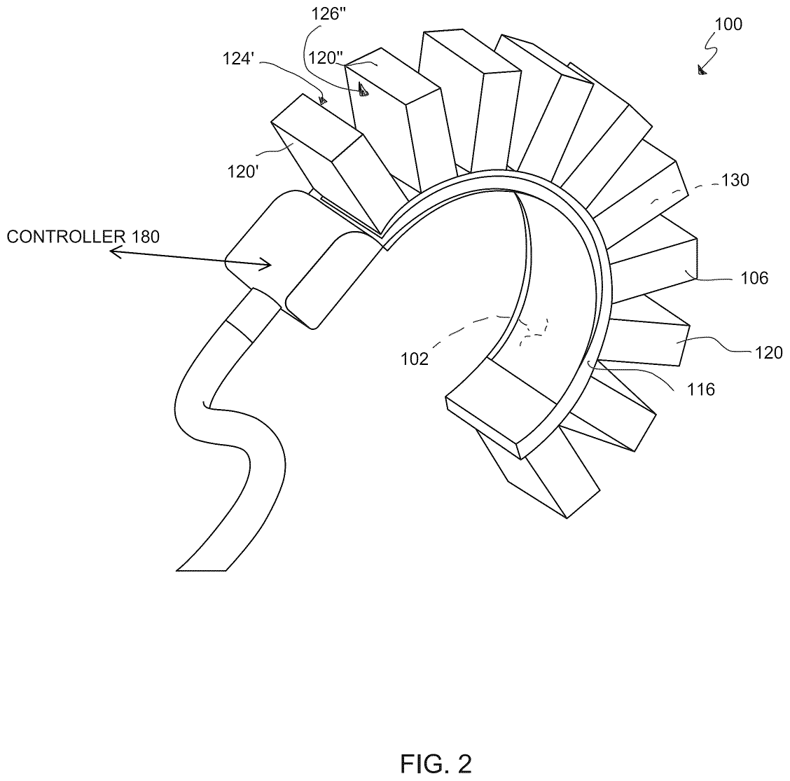

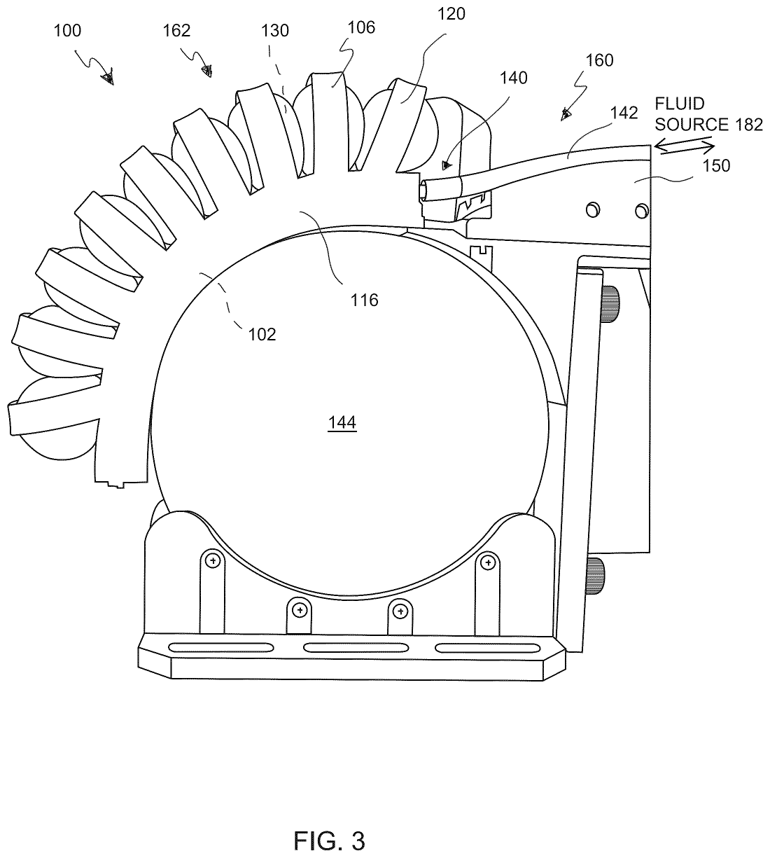

FIG. 2 shows additional details of the NDT system 100 including the flexible ultrasound array 102 and the actuatable soft robot system 106 in an actuated configuration. The flexible ultrasound array 102 is surrounded by the housing 116. The actuatable soft robot system 106 in FIG. 2 includes ten retractable segments 120. FIG. 2 shows a first retractable segment 120′ and a second retractable segment 120″ useful for demonstration purposes. A front wall 124′ of the first retractable segment 120′ is at least partially expanded. A rear wall 126″ of the second retractable segment 120″ is at least partially expanded. The front and rear walls can expand and contract based on fluid ported to the inside of the retractable segments. As the walls expand and contract, they press against one another. As the walls expand and press against one another, the actuatable soft robot system 106 and the housing 116 curve to adapt to the displacement caused by the pressure within the chambers 130 of the retractable segments 120. The curvature of the housing 116 caused by the displacement of the actuatable soft robot system 106 allows the flexible ultrasound array 102 to conform to curved surfaces in order to non-destructively evaluate curved surfaces. For example, the test piece shown in FIG. 3.

Referring to FIG. 3, another example of a NDT system 100 is shown partially surrounding a test piece 144. The example shown in FIG. 3 includes a head portion 160 and a body portion 162. The NDT system 100 includes the flexible ultrasound array 102, the housing 116, and the actuatable soft robot system 106. The actuatable soft robot system 106 is actuated with a fluid ported to the actuatable soft robot system 106 via a fluid port 140 through a tube 142. The tube 142 may supply a fluid (e.g., air, water, hydraulic fluid, oil, etc.) to the chambers 130 of the retractable segments 120. The chambers 130 expand as explained herein. In the exemplary but non-limiting figure shown in FIG. 3, the actuatable soft robot system 106 and the housing 116 curve to surround the test piece 144. The flexible ultrasound array 102 can then be used to locate defects or other aspects within the test piece or other object. For example, using the methods described in U.S. Pat. No. 11,628,470, which is herein incorporated by reference in its entirety.

Briefly referring back to FIG. 1, Step B, the actuatable soft robot system 106 may be formed using a four-part mold 170. A first part 172 may be used to define an interior of the actuatable soft robot system 106 and a second part 174 may be used to define an exterior part of the actuatable soft robot system 106. Two metal rods 176 are used to create channels (i.e., fluid ports 122) to connect each inflatable section. The rods 176 can be removed once the piece is cast.

The controller 180 (only schematically shown) may include one or more microprocessors or one or more microcontrollers to process data, input channels to receive sensor signals, output channels to control actuators, and potentially a display to show system status. For example, with reference to FIGS. 1 and 3, the controller 180 may control one or more valves or other mechanisms for controlling the porting of fluid from a fluid source 182 (only schematically depicted) for porting fluid to the NDT system 100.

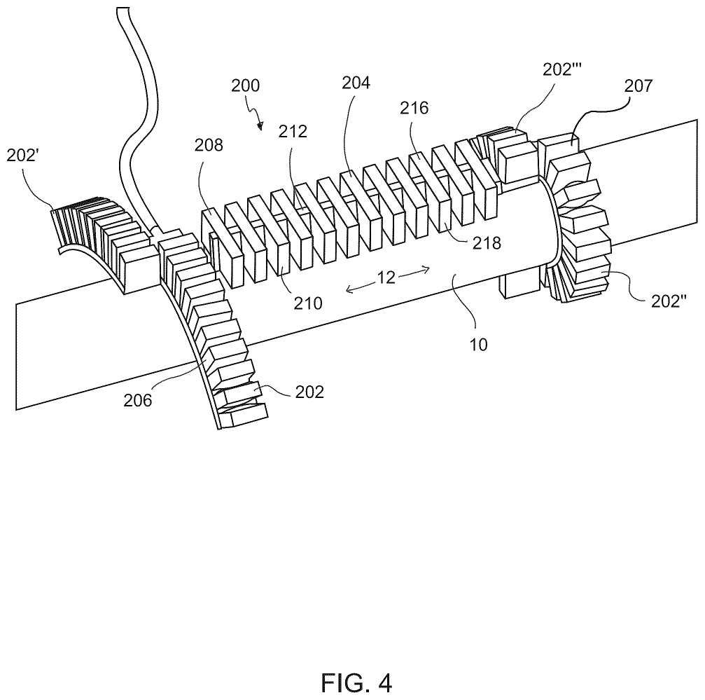

Referring now to FIG. 4, a soft robot crawler NDT system 200 for conducting NDT on a workpiece 10 is shown. The soft robot crawler NDT system 200 can move back and forth along the workpiece 10 in the direction shown at arrows 12 as described herein, or in potentially other ways. The soft robot crawler NDT system 200 shown in FIG. 4 includes a forward NDT system 206 and a rear NDT system 207. Each of the forward NDT system 206 and the rear NDT system 207 includes one or more NDT systems 202, which are substantially similar to the NDT system 100 of FIGS. 1-3. The NDT systems 202, 202′, 202″, 202′″ can surround the workpiece 10 and travel based on movement caused by a crawler 204. The crawler 204 can include a first leg 208 and a second leg 210. The first leg 208 can include a first series of segments 216 and the second leg 210 can include a second series of segments 218.

The first series of segments 216 and the second series of segments 218 may be expanded and contracted to expand and contract, respectively, a length of the crawler 204. That is, a fluid (e.g., hydraulic fluid, pneumatic fluid, etc.) may be ported to or from the segments as described herein to create a positive pressure or a vacuum within chambers of the segments. As the chambers expand or contract they will increase or decrease their volume, respectively. Because they are sequential along a length of the crawler 204, the length of the crawler will expand and contract in turn. As the crawler expands and contracts, alternating ones of the forward NDT system 206 and the rear NDT system 207 engage to “grasp” the workpiece 10. So, as shown in FIG. 4, the rear NDT system 207 is engaged to the workpiece 10 (i.e., the chambers in the NDT systems 202″, 202′″ are inflated) and the systems curve to grasp the workpiece 10.

Simultaneously, the forward NDT system 206 is allowed to disengage from the workpiece 10. That is, the fluid used to create pressure within the chambers may be allowed to escape reducing pressure within the chambers. So the forward NDT system 206 disengages the workpiece 10 as the rear NDT system 207 engages and the first series of segments 216 and the second series of segments 218 expand, increasing the length of the crawler 204. The sufficient friction with the workpiece 10 applied by the rear NDT system 207 and expanding of the series of segments allows the forward NDT system 206 to move along the workpiece 10. Subsequently, forward NDT system 206 engages the workpiece 10, the rear NDT system 207 relieves the pressure in the chambers, disengaging the workpiece 10, and the first and second series of segments 216, 218 also relieve pressure, such that the length of the crawler 204 decreases. This process is repeated as the soft robot crawler NDT system 200 moves along the length of the workpiece 10.

In alternative embodiments, the first series of segments 216 and the second series of segments 218 can alternately expand and contract to move the soft robot crawler NDT system 200 forward and backward along the length of the workpiece 10. Each of the segments in the various series of segments operates substantially similarly to the segments 120 shown in FIGS. 1-3 to expand and contract (i.e., retract). Because only one of the first leg 208 and the second leg 210 is expanding and retracting or the first leg 208 and the second leg 210 are alternating their expansion and contraction, the soft robot crawler NDT system will “wiggle” forward and backward along the workpiece.

In yet other embodiments, the crawler 204 of the soft robot crawler NDT system 200 may simply include one series of segments that can alternatively expand and contract to increase and decrease the length of the crawler 204 to cause the soft robot crawler NDT system 200 to crawl along the workpiece.

While the present disclosure has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The disclosure in its broader aspects is therefore not limited to the specific details, representative apparatus and method, and illustrative examples shown and described. Accordingly, departures may be made from such details without departing from the scope of the general inventive concept.

What is claimed is:

1. A non-destructive testing (NDT) system comprising:
a flexible ultrasound array including an array surface;
a controller for controlling the flexible ultrasound array; and
an actuatable soft robot system comprising an actuator mechanism for actuating the flexible ultrasound array to modify a shape of the array surface of the flexible ultrasound array.

2. The non-destructive testing system of claim 1, the actuator mechanism comprising a plurality of retractable segments, each retractable segment comprising one or more expandable portions, wherein the expandable portions of a first retractable segment expand to press against a second retractable segment, to flex the array surface of the flexible ultrasound array.

3. The NDT system of claim 2, wherein the retractable segment includes one or more expandable portions and one or more rigid portions.

4. The NDT system of claim 3, wherein the expandable portions of one or more of the retractable segments comprise one or more thin, flat panels capable of expanding to contact and push another of the retractable segments.

5. The NDT system of claim 2, wherein at least two of the plurality of retractable segments are coupled with one another via at least one channel.

6. The NDT system of claim 5, wherein the plurality of retractable segments that are coupled via the channel are pneumatically coupled.

7. The NDT system of claim 2, wherein the flexible ultrasound array is at least partially enclosed in a silicone elastomer housing.

8. The NDT system of claim 7, wherein the flexible ultrasound array is partially surrounded by the silicone elastomer housing and is partially surrounded by a polytetrafluoroethylene (PTFE) tape.

9. The NDT system of claim 8, wherein the PTFE tape encloses an open top portion of the silicone elastomer surrounding the flexible ultrasound array.

10. The NDT system of claim 7, wherein the silicone elastomer housing is bonded with the plurality of retractable segments.

11. A flexible ultrasound robot for non-destructive testing comprising:
a head comprising:
a coupler for coupling the flexible ultrasound robot to a controller; and
a fluid interface for coupling the flexible ultrasound robot with a fluid supply and fluid return for controlling a motion of the flexible ultrasound robot,
a body comprising:
a flexible ultrasound array including an array surface; and
an actuatable soft robot system comprising an actuator mechanism for actuating the flexible ultrasound array to flex the array surface of the flexible ultrasound array.

12. The flexible ultrasound robot of claim 11, wherein the actuator mechanism includes a plurality of retractable segments, each retractable segment comprising one or more expandable portions, wherein the expandable portions of a first retractable segment expand to press against a second retractable segment, to flex the array surface of the flexible ultrasound array.

13. The flexible ultrasound robot of claim 12, wherein the retractable segment includes one or more expandable portions and one or more rigid portions.

14. The flexible ultrasound robot of claim 13, wherein the expandable portions of one or more of the retractable segments comprise one or more thin, flat panels capable of expanding to contact and push another of the retractable segments.

15. The flexible ultrasound robot of claim 12, wherein at least two of the plurality of retractable segments are coupled with one another via at least one channel.

16. The flexible ultrasound robot of claim 15, wherein the plurality of retractable segments that are coupled via the channel are pneumatically coupled.

17. The flexible ultrasound robot of claim 12, wherein the flexible ultrasound array is at least partially enclosed in a silicone elastomer housing.

18. The flexible ultrasound robot of claim 17, wherein the flexible ultrasound array is partially surrounded by the silicone elastomer housing and is partially surrounded by a polytetrafluoroethylene (PTFE) tape.

19. The flexible ultrasound robot of claim 18, wherein the PTFE tape encloses an open top portion of the silicone elastomer surrounding the flexible ultrasound array.

20. The flexible ultrasound robot of claim 17, wherein the silicone elastomer housing is bonded with the plurality of retractable segments.
